(19) United States
(12) Patent Application Publication
(10) Pub. No.: US 2013/0016187 A1
(43) Pub. Date: Jan. 17, 2013

(54) METHOD AND APPARATUS FOR AUTO-CONVERGENCE FOR STEREOSCOPIC IMAGES AND VIDEOS

(71) Applicants: Buyue Zhang, Plano, TX (US); Aziz Umit Batur, Dallas, TX (US)

(72) Inventors: Buyue Zhang, Plano, TX (US); Aziz Umit Batur, Dallas, TX (US)

(73) Assignee: TEXAS INSTRUMENTS INCORPORATED, Dallas, TX (US)

(21) Appl. No.: 13/549,928

(22) Filed: Jul. 16, 2012

Related U.S. Application Data
(60) Provisional application No. 61/507,930, filed on Jul. 14, 2011.

(51) Int. Cl. H04N 13/02

(52) U.S. Cl. 348/47; 348/E13.074; 348/E13.014

(57) ABSTRACT

A method and apparatus for reducing convergence accommodation conflict. The method includes estimating disparities between images for different lens, analyzing the estimated disparities, selecting a point of convergence, determining the amount of shift relating to the convergence point selected, and performing adjustment to the disparity to maintain a disparity value below a threshold.

### CROSS-REFERENCE TO RELATED APPLICATIONS

This application claims benefit of U.S. provisional patent application Ser. No. 61/507,930, filed Jul. 14, 2011, which is herein incorporated by reference.

### BACKGROUND OF THE INVENTION

1. Field of the Invention

Embodiments of the present invention generally relate to a method and apparatus for auto-convergence for stereoscopic images and video.

2. Description of the Related Art

The commercial success of three dimensional movies is generating great interest in stereoscopic three dimensional capture and display technologies. Three dimensional capable TVs, digital cameras, and mobile devices are entering the consumer electronics market, which enable consumers capture and display their own three dimensional content. However, a major challenge to the success of these three dimensional capable devices is the viewing comfort. Consumer three dimensional cameras have fixed camera separation and orientation, and the three dimensional display viewing distance is typically short. Such devices, usually use stereo cameras. Since stereo cameras include more than one lens, usually two, lens separation causes a horizontal offset. The horizontal offset is utilized to create a depth perception.

The convergence point of human visual system is the point of intersection of the two eye axes. Similarly, the convergence point of a stereoscopic camera system is the intersection of the two axes of the lenses of the cameras. Since there is a distance between the lenses of the two cameras, the same object usually project onto different locations on the camera sensors. The distance in coordinates along the epipolar line is called disparity. At the distance of the convergence point, disparity is zero. Objects closer than the convergence distance have negative disparities, while objects farther than the convergence distance have positive disparities.

When stereo content is shown on a stereoscopic display, objects with zero disparity will appear to be on the screen. Objects with negative disparity will be popped out from the screen. Object with positive disparity will be pushed behind the screen. Therefore, the convergence point is very important in determining the perceived depth of the different objects in the stereo content. Large negative disparity and large positive disparity, both, cause our brain to experience difficulty in fusing the left and the right views to render a three dimensional scene. Such difficulty creates eye strain and headaches. Unfortunately, stereoscopic cameras and displays, by themselves, have no sense of the amount of disparity for eye comfort. Therefore, an auto convergence algorithm is needed by these devices to help adjust the disparities in the three dimensional content.

Without auto convergence, three dimensional contents, which are captured from stereo cameras with fixed separation, are usually difficult for our eyes to look at because of the pronounced vergence-accommodation conflict, i.e., when displayed on a hand-held device. It is also undesirable and impractical for consumers to manually adjust convergence for all their three dimensional videos and images.

Hence, a bottleneck for the success of consumer three dimensional cameras is the viewing comfort. Consumer three dimensional cameras have fixed camera separation, and the three dimensional display viewing distance is typically short. For these reasons, the vergence-accommodation conflict is particularly pronounced, which causes discomfort and eye fatigue. Therefore, a Stereo Auto Convergence (SAC) algorithm is needed to reduce the vergence-accommodation conflict on the three dimensional display by adjusting the depth of the three dimensional scene automatically.

### SUMMARY OF THE INVENTION

Embodiments of the present invention relate to a method and apparatus for reducing convergence accommodation conflict. The method includes estimating disparities between images for different lens, analyzing the estimated disparities, selecting a point of convergence, determining the amount of shift relating to the convergence point selected, and performing adjustment to the disparity to maintain a disparity value below a threshold.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment depicting disparities estimation blocks;

FIG. 2 is an embodiment depicting effects of the median filtering followed by the temporal filtering;

FIG. 3 is an embodiment depicting auto convergence center mode;

FIG. 4 is an embodiment depicting auto convergence frame mode; and

FIG. 5 is a flow diagram depicting an embodiment of a method for reducing the vergence-accommodation conflict.

### DETAILED DESCRIPTION

Described herein are a method and an apparatus that remedy the effects caused by the disparity of the images/videos of a stereoscopic device. The method and the apparatus automatically determine the amount of horizontal shift needed for adjusting stereoscopic image/video pairs in order to achieve comfortable three dimensional viewing experience.

The disparities are estimated between the left and the right views available from a stereo camera. Based on the disparities, the different strategies are utilized to shift the two views horizontally. Such a shift allows the objects in the scene to achieve desirable depth when viewed by observers. As a result, the automatic determination of the horizontal shift provides for a stability method and a quick reaction to changes in a scene.

Such a method/apparatus produces pleasant stereo three dimensional effects. It is fast in response to scene change, while stable to small disturbances from unwanted movement, such as, hand jittering. It is efficient and easily implemented in real-time.

In one embodiment, the goal is to provide a high quality three dimensional viewing experience. In one embodiment, scene changes are responded to quickly and method/apparatus is stable and robust to unwanted movement and disturbances, such as, hand jittering. The maximal and minimal disparities of a scene are checked and the depth is reduced as needed to make sure our eyes can comfortable fuse the amount of depth in the content. Ideally, such a solution is efficient.

The left and the right images/videos captured by a stereo camera may be utilized as input. The amount of disparity change is computed and needed to adjust the multiple views, i.e., two, in order to render desired a three dimensional effect. The module, after the auto convergence module, will then apply the amount of disparity change to the views by shifting them horizontally, either towards each other, or farther away from each other. In one embodiment, the method includes: disparity estimation, disparity filtering, determining convergence point, disparity safety check, and stabilization of disparity change.

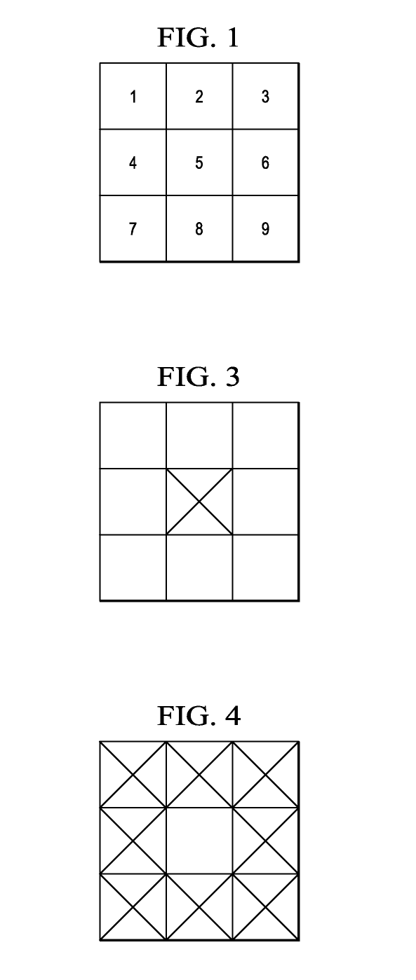

After estimating the disparities between the left and right views, we apply temporal median filtering is applied utilizing equation (1) to clean up and stabilize the estimated disparities for blocks in a frame, i.e. all blocks, as shown in FIG. 1. FIG. 1 is an embodiment depicting disparities estimation blocks. In FIG. 1, Each frame is divided into K×L number of blocks. Disparities between the left and the right view are estimated for these blocks only to save computation. In our implementation, K=3 and L=3.

$${Disp}_{MF} = {\overline{Disp}}_{i n} ( ⌊ \frac{N}{2} ⌋ ) , \qquad ( 1 )$$

where D̅i̅s̅p̅ᵢₙ is the sorted disparity in ascending order from the past N frames, └•┘ is a floor operator or ceiling operation, and N is the length of the disparity history buffer, i.e. N may be around 15.

Hence, if convergence point keeps shifting, it can be very uncomfortable to the eye. Therefore, an N frame observation time is imposed on large disparity change, i.e., if ΔDisp is greater than a threshold DisparityUpdateThreshold, we only update ΔDisp_out when N consecutive frames with ΔDisp greater than DisparityUpdateThreshold are observed. When ΔDisp is smaller than DisparityUpdateThreshold, we only continue to update ΔDisp_out for K frames, and stop updating ΔDisp_out afterwards until the next time ΔDisp is greater than DisparityUpdateThreshold AND that the N frame observation time is satisfied. In one embodiment, N is set to 3 and K is set to 10.

Median filtering is applied to the blocks, which maybe applied to all blocks independently in the temporal direction. After median filtering, temporal smoothing is applied to the disparities to make the disparity change smoother, as shown in equation (2).

Disp_{TF}(n)=(1−α)·Disp_{TF}(n−1)+α·Disp_{MF}(n), (2)

where Disp_{TF} is the temporal filtered disparity, α is the strength of the filter which controls how fast the result converges to Disp_{MF}, and n is frame index.

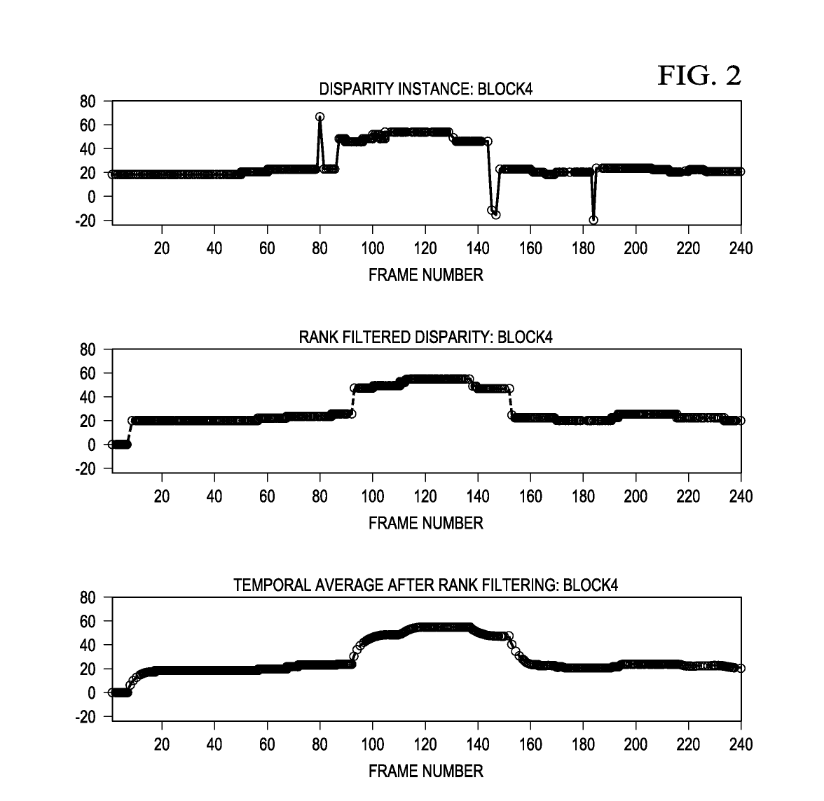

FIG. 2 is an embodiment depicting the effect of the median filtering followed by the temporal filtering. In FIG. 2, a comparison of the original disparity estimates (top), the original disparities after medium filtering (middle), and the medium filtered disparities after further temporal smoothing (bottom). In FIG. 2, the top plot in FIG. 2 shows the original disparity values from the center block (block 5) for the past 240 frames. The spikes are erroneous disparity estimates. The center plot in FIG. 2 shows the disparity for the center block after rank order filtering, where the incorrect outliners are eliminated. The bottom plot shows the disparity after further temporal smoothing. The resultant disparity is much more stable and smooth compared to the original disparity values.

The convergence point is usually the location in the frame whose disparity will be set to zero after auto convergence. The disparity of the convergence point tells the amount of disparity change needed in order to converge at this point. There are several modes of convergence in determining the convergence point: center mode, frame mode, and touch mode. These different modes can be selected by the user through the camera/display manual.

FIG. 3 is an embodiment depicting auto convergence center mode. In Center Mode, the auto convergence algorithm converges at the center block, as shown in FIG. 3. Assuming the disparity values of the 9 blocks are Dispᵢ, i=1, 2, . . . , 9, disparity of the center block is Disp₅, the amount of disparity change that would put center block on the screen (i.e., zero disparity) is given in equation (3). If the center block disparity is invalid, disparity change is set to zero.

$$Δ Disp = \{ \begin{matrix}- {Disp}_{5} , & I ( 5 ) = 1 \\ 0 , & I ( 5 ) = 0\end{matrix} , \qquad ( 3 )$$

where I/(k) is validity indicator function. I(k) is 1 if the disparity of block k is valid, and 0 if invalid, k=1,2, . . . 9.

FIG. 4 is an embodiment depicting auto convergence frame mode. In frame mode, the auto convergence algorithm converges on the surrounding blocks, i.e., excluding the center block, shown in FIG. 4. To make the disparity change stable, the largest disparity and the smallest disparity are excluded from determining the target disparity. Moreover, the disparities of the rest of the non-center blocks are averaged to get final target disparity value. The amount of disparity change is computed according to equations (4)-(5).

$$\begin{matrix}{Disp}_{target} = \frac{{\sum }_{i ∈ Φ} {Disp}_{i}}{{\sum }_{i ∈ Φ} I ( {Disp}_{i} )} , where \\ Φ = \{ i \vert i \neq 5 , i \neq {arg max}_{k} ( {Disp}_{k} ) , and i \neq {arg min}_{k} ( {Disp}_{k} ) \} & ( 4 ) \\ Δ Disp = \{ \begin{matrix}- {Disp}_{targe} , & \sum I ( Φ ) \geq 2 \\ 0 , & otherwise\end{matrix} , & ( 5 )\end{matrix}$$

In this mode, the user selects the region for convergence by touch selecting a position on the display. The coordinates of the selected convergence point is then converted into the corresponding coordinates in which the auto convergence algorithm is running Next, the location is mapped to one of the 9 blocks. Finally, disparity change is determined by (6):

$$Δ Disp = \{ \begin{matrix}- {Disp}_{T} , & I ( T ) = 1 \\ 0 , & otherwise\end{matrix} , \qquad ( 6 )$$

where Disp_{T} is the disparity of the block touch selected by the user.

To ensure a comfortable three dimensional viewing experience for the user, we check what would be the maximal disparity and the minimal disparity in the frame after applying the amount of disparity change determined in Sec. II. Disparity change ΔDisp is then adjusted according to equations (7) and (8):

If:

(ΔDisp+min{Dispᵢ})<minNegDisparity, ΔDisp←minPosDisparity−min{Dispᵢ}, i=1,2, . . . ,9 (7)

If

(ΔDisp+max{Dispᵢ})>maxPosDisparity, ΔDisp←maxPosDisparity−max{Dispᵢ}, i=1,2, . . . ,9 (8),

where minNegDisparity and maxPosDisparity are the respective minimal and maximal disparities allowed to ensure a comfortable three dimensional viewing experience. These values should be adjusted according to the display resolution and viewing distance. min{•} is the operation of finding minimum and max {•} is the operation of finding maximum values, respectively.

An IIR filter is used to smooth out the final output disparity change ΔDisp_out, as follows:

ΔDisp_out(n)=β·ΔDisp_out(n−1)+(1−β)·ΔDisp(n), (9)

where n is the temporal frame index and (1−β) is the disparity change update rate.

To make the auto convergence algorithm responsive to scene change which is usually associated with large ΔDisp, we make β adaptable to ΔDisp as shown in (10)-(11). The smaller β is, the faster ΔDisp_out(n) converges to ΔDisp(n).

$$\begin{matrix}β = \{ \begin{matrix}\frac{θ - λ * Δ Disp}{256} , & if ( θ - λ * Δ Disp ) \geq 128 \\ 0.5 , & otherwise\end{matrix} , & ( 10 ) \\ λ = \{ \begin{matrix}2 , & if ( \frac{1500}{M} ) < 2 \\ 4 , & if ( \frac{1500}{M} ) > 4 \\ ( \frac{1500}{M} ) , & otherwise\end{matrix} , & ( 11 )\end{matrix}$$

where θ=203 and M is the width of the frame size

Hence, by adjusting the depth of the three dimensional scene automatically, Stereo Auto Convergence (SAC) maybe utilized for three dimensional devices for reducing the vergence-accommodation conflict on the three dimensional display. Such a method and apparatus processes stereo video/images in real-time and shifts each stereo frame horizontally by an appropriate amount in order to converge on a chosen object in that frame.

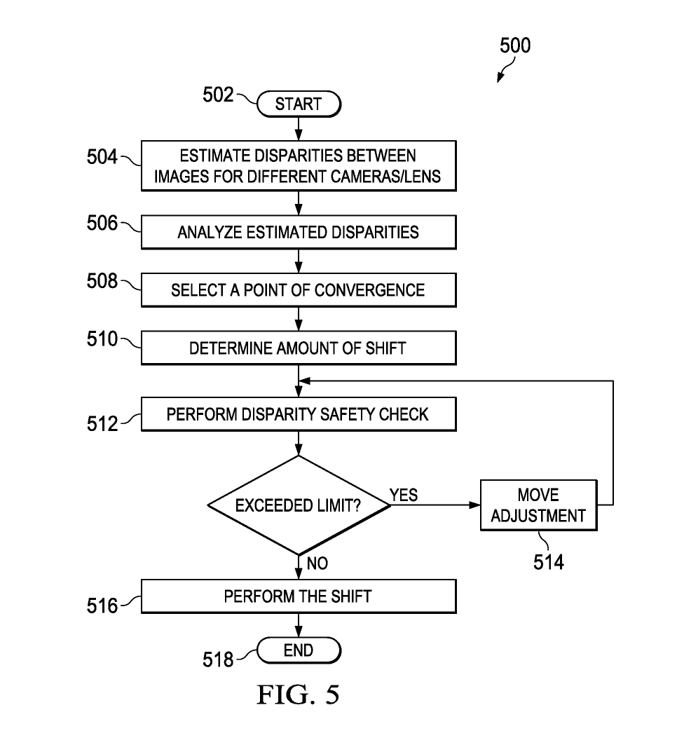

FIG. 5 is a flow diagram depicting an embodiment of a method 500 for reducing the vergence-accommodation conflict. The method starts at step 502 and proceeds to step 504. At step 504, the method 500 estimates disparities between images from different lens/cameras using correlations of the horizontal projections of the frame, i.e. the left and right image pairs using correlations of the horizontal projections of the frame. At step 506, the method 500 analyzes the estimated disparities. At step 508, the method 500 selects a point of convergence according to a center-convergence or surround-convergence strategy.

At step 510, the method 500 determines the amount of shift, i.e. the current and the target disparities of the chosen convergence point determine how much horizontal shift is needed. At step 512, the method 500 performs disparity safety check to determine whether or not the maximum and minimum disparity limits have been exceeded after auto convergence. At step 514, the method 500 determines if the limits have been exceeded. At step 514, if the limits have been exceeded, further adjustments are made to satisfy the safety limits. Otherwise, the method proceeds to step 516, wherein the limits are not exceeded. At step 516, the method 500 performs convergence by shifting the frames accordingly. The method ends at step 518.

In one embodiment, the method and apparatus utilizing Stereo Auto Convergence (SAC) algorithm are utilized for consumer three dimensional mobile cameras for reducing the vergence-accommodation conflict on the three dimensional display. The reduction is done by adjusting the depth of the three dimensional scene, in some cases automatically. The algorithm may process stereo video in real-time and may shift video frame, i.e. horizontally, by an appropriate amount to converge on a chosen object in that frame. After auto-convergence, stereo video is much more pleasant to view on a three dimensional display.

While the foregoing is directed to embodiments of the present invention, other and further embodiments of the invention may be devised without departing from the basic scope thereof, and the scope thereof is determined by the claims that follow.

What is claimed is:

1. A method for reducing convergence accommodation conflict, comprising:
estimating disparities between images for different lens;
analyzing the estimated disparities;
selecting a point of convergence;
determining the amount of shift relating to the convergence point selected; and
performing adjustment to the disparity to maintain a disparity value below a threshold.

2. An apparatus for reducing convergence accommodation conflict, comprising:
means for estimating disparities between images for different lens;
means for analyzing the estimated disparities;
means for selecting a point of convergence;
means for determining the amount of shift relating to the convergence point selected; and
means for performing adjustment to the disparity to maintain a disparity value below a threshold.

3. A non-transitory computer readable medium with executable computer instructions, when executed perform a method for reducing convergence accommodation conflict, the method comprising:
estimating disparities between images for different lens;
analyzing the estimated disparities;
selecting a point of convergence;
determining the amount of shift relating to the convergence point selected; and
performing adjustment to the disparity to maintain a disparity value below a threshold.
